(19) United States
(12) Patent Application Publication
(10) Pub. No.: US 2025/0073849 A1
(43) Pub. Date: Mar. 6, 2025

(54) SANDING DEVICE

(71) Applicants: Hyundai Motor Company, Seoul (KR); Kia Corporation, Seoul (KR)

(72) Inventor: Jeong Hwan Ha, Gyeongju-si (KR)

(21) Appl. No.: 18/667,204

(22) Filed: May 17, 2024

(30) Foreign Application Priority Data
Aug. 29, 2023 (KR) 10-2023-0113328

(51) Int. Cl. B24B 49/16; B24B 41/00; B24B 41/04; B24B 47/12; B24B 47/14

(52) U.S. Cl. CPC B24B 49/16; B24B 41/002; B24B 41/04; B24B 47/12; B24B 47/14

(57) ABSTRACT

An embodiment sanding device includes a housing mountable on an arm of a robot, a sanding tool assembly rotatably installed on the housing by a spindle shaft, and a sanding pressure regulating unit coaxially connected to the spindle shaft and configured to regulate sanding pressure of the sanding tool assembly applied to a coating film while reciprocating the spindle shaft in an axial direction.

### CROSS-REFERENCE TO RELATED APPLICATIONS

This application claims the benefit of Korean Patent Application No. 10-2023-0113328, filed on Aug. 29, 2023, which application is hereby incorporated herein by reference.

### TECHNICAL FIELD

Embodiments of the present disclosure relate to a sanding device.

### BACKGROUND

In general, a process of coating a vehicle body coats a surface of the vehicle body with a coating material. Further, the process of coating the vehicle body performs a sanding process to remove fine foreign substances on a coating film applied onto the vehicle body or to remove a defective portion of the coating film. The sanding process is performed by a sanding device mounted on an arm of a robot.

A sanding device according to an example of the related art includes a sanding tool configured to rotate a sanding pad by an operation of a motor and a pressure regulator (e.g., a pressure regulating mechanism) configured to press the sanding pad of the sanding tool with preset pressure.

In this case, for example, the pressure regulator has a pressure regulating table configured to be reciprocated by pneumatic pressure. The pressure regulator is mounted on the arm of the robot, and the sanding tool is mounted on the pressure regulating table.

Therefore, the sanding device according to the example of the related art is configured to use the pressure regulator and compensate, in real time, for a change in pressing force of the sanding pad made by a movement of the robot during a process in which the sanding pad of the sanding tool sands the coating film of the vehicle body.

However, because the sanding device according to the example of the related art has the sanding tool and the pressure regulator that are separately provided, which may increase costs because of the application of the comparatively expensive pressure regulator.

Further, the sanding device according to the example of the related art cannot be mounted on a small-scale robot because of weights (e.g., heavy weights) of the sanding tool and the pressure regulator, but it is inevitably mounted on a robot having a middle or large scale, which may cause an increase in facility investment costs.

In addition, the sanding device according to the example of the related art adopts the sanding tool and the pressure regulator that are comparatively heavy in weight, which makes it difficult to adjust an operating position of the robot because of inertia of the arm of the robot.

Therefore, according to the sanding device according to the example of the related art, the pressure regulator cannot regulate and maintain fine pressure of the sanding tool while the process of sanding the coating film of the vehicle body is performed in a micron scale.

The above information disclosed in this background section is only for enhancement of understanding of the background of embodiments of the invention and therefore it may contain information that does not form the already known prior art.

### SUMMARY

Embodiments of the present disclosure relate to a sanding device. Particular embodiments relate to a sanding device configured to sand a coating film applied onto a vehicle body.

Embodiments of the present disclosure provide a sanding device in which a mechanism for sanding a coating film of a vehicle body and a mechanism for regulating sanding pressure are integrated into a simple configuration.

A sanding device according to an embodiment of the present disclosure may be configured to sand a coating film applied onto a vehicle body and may include: i) a housing mounted on an arm of a robot; ii) a sanding tool assembly rotatably installed on the housing by a spindle shaft; and iii) a sanding pressure regulating unit coaxially connected to the spindle shaft and configured to regulate sanding pressure of the sanding tool assembly applied to the coating film while reciprocating the spindle shaft in an axial direction.

In addition, the sanding device according to an embodiment of the present disclosure may further include a main driving source including a motor installed on the housing, a power transmission assembly installed in the housing and configured to transmit rotational power of the motor to the spindle shaft along a preset power transmission route, and a shaft connecting assembly connected to a rotational power output part of the power transmission assembly and configured such that the spindle shaft is coupled to the shaft connecting assembly so as to be movable in the axial direction.

In addition, in the sanding device according to an embodiment of the present disclosure, the sanding pressure regulating unit may include a sub-driving source including an air cylinder installed on the housing and a shaft joint assembly installed on the spindle shaft and connected to the air cylinder in the axial direction of the spindle shaft.

In addition, in the sanding device according to an embodiment of the present disclosure, the spindle shaft and the air cylinder may be connected by the shaft joint assembly in a coaxial direction perpendicular to the power transmission route.

In addition, in the sanding device according to an embodiment of the present disclosure, the spindle shaft may be reciprocated in the axial direction by the air cylinder while being rotated by an operation of the motor.

Further, a sanding device according to another embodiment of the present disclosure may be configured to sand a coating film applied onto a vehicle body and may include: i) a housing mounted on an arm of a robot; ii) a main driving source including a motor installed on the housing; iii) a power transmission assembly including a rotational power input part connected to the motor and a rotational power output part connected to the rotational power input part; iv) a spindle rotatably coupled to a spindle housing fixed to the housing, the spindle being connected to the rotational power output part; v) a spindle shaft coupled to the spindle so as to be movable in an axial direction; vi) a sanding tool assembly installed on the spindle shaft; and vii) a sanding pressure regulating unit coaxially connected to the spindle shaft and configured to regulate sanding pressure of the sanding tool assembly applied to the coating film while reciprocating the spindle shaft in the axial direction by an operation of a sub-driving source.

In addition, in the sanding device according to an embodiment of the present disclosure, the sanding pressure regulating unit may include a shaft joint assembly installed on the spindle shaft and connected to the sub-driving source.

In addition, in the sanding device according to an embodiment of the present disclosure, the power transmission assembly may include a driving pulley provided as the rotational power input part rotatably installed in the housing, a driven pulley provided as the rotational power output part connected to the spindle, and a timing belt configured to connect the driving pulley and the driven pulley in the form of an endless track.

In addition, in the sanding device according to an embodiment of the present disclosure, the spindle may include a spindle hole formed in the axial direction and a plurality of spline grooves formed in an inner peripheral surface of the spindle hole in the axial direction.

In addition, in the sanding device according to an embodiment of the present disclosure, the spindle shaft may include a plurality of spline protrusions formed on an outer peripheral surface thereof in the axial direction and coupled to the plurality of spline grooves.

In addition, in the sanding device according to an embodiment of the present disclosure, the sanding tool assembly may include a tool mounting part coupled to the spindle shaft and a sandpaper mounted on the tool mounting part.

In addition, in the sanding device according to an embodiment of the present disclosure, the sub-driving source may include an air cylinder installed on the housing and coaxially connected to the shaft joint assembly by an operating rod.

In addition, in the sanding device according to an embodiment of the present disclosure, the shaft joint assembly may include a push pin coupled to the operating rod of the air cylinder, a bearing adapter coupled to the spindle shaft, and a bearing member fixed to the bearing adapter and connected to the push pin.

In addition, in the sanding device according to an embodiment of the present disclosure, the bearing member may be coupled to the bearing adapter by an outer race and coupled to the push pin by an inner race.

In addition, in the sanding device according to an embodiment of the present disclosure, the bearing adapter may be provided in the form of a bushing and coupled to the spindle shaft through a pulley hole formed in a driven pulley provided as the rotational power output part.

According to the sanding device according to an embodiment of the present disclosure, an overall weight and manufacturing costs may be reduced, and facility investment costs may be reduced because the sanding device may be applied to the small-scale robot.

Other effects, which may be obtained or expected by the embodiments of the present disclosure, will be directly or implicitly disclosed in the detailed description of the embodiments of the present disclosure. That is, various effects expected according to the embodiments of the present disclosure will be disclosed in the detailed description to be described below.

### BRIEF DESCRIPTION OF THE DRAWINGS

Because the drawings are provided for reference to describe embodiments of the present disclosure, the technical spirit of the embodiments of the present disclosure should not be construed as being limited to the accompanying drawings.

FIG. 1 is a side view illustrating a sanding device according to an embodiment of the present disclosure.

FIGS. 2 and 3 are coupled perspective views illustrating the sanding device according to an embodiment of the present disclosure.

FIG. 4 is a partially cut-away perspective view illustrating the sanding device according to an embodiment of the present disclosure.

FIG. 5 is an exploded perspective view illustrating the sanding device according to an embodiment of the present disclosure.

FIG. 6 is an exploded perspective view illustrating a coupling structure between a shaft connecting assembly and a spindle shaft applied to the sanding device according to an embodiment of the present disclosure.

FIG. 7 is a view illustrating a part of a sanding tool assembly applied to the sanding device according to an embodiment of the present disclosure.

FIG. 8 is a view illustrating a part of a sanding pressure regulating unit applied to the sanding device according to an embodiment of the present disclosure.

It should be understood that the accompanying drawings are not necessarily to scale, but they provide a somewhat simplified representation of various preferred features that exemplify the basic principles of embodiments of the present disclosure. For example, specific design features of embodiments of the present invention, including particular dimensions, directions, positions, and shapes, will be partially determined by the particularly intended application and use environment.

### DETAILED DESCRIPTION OF ILLUSTRATIVE EMBODIMENTS

Hereinafter, embodiments of the present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein.

A part irrelevant to the description will be omitted to clearly describe embodiments of the present disclosure, and the same or similar constituent elements will be designated by the same reference numerals throughout the specification.

In addition, the size and thickness of each component illustrated in the drawings are arbitrarily shown for ease of description, but embodiments of the present disclosure are not limited thereto. In order to clearly describe several portions and regions, thicknesses thereof are enlarged.

The terms used in the present specification are for explaining the exemplary embodiments, not for limiting the present disclosure. The singular expressions used herein are intended to include the plural expressions unless the context clearly dictates otherwise.

In addition, it is to be understood that the term “comprise (include)” and/or “comprising (including)” used in the present specification means that the features, the integers, the steps, the operations, the constituent elements, and/or the components are present, but the presence or addition of one or more of other features, integers, steps, operations, constituent elements, components, and/or groups thereof is not excluded.

Further, the term ‘coupled’ used in the present specification indicates a physical relationship between two components that are connected directly to each other or connected indirectly through one or more intermediate components.

Furthermore, in the present specification, the term ‘operably connected’ or another similar term means that at least two members may be connected directly or indirectly to each other and transmit power. However, the two members, which are operably connected to each other, do not always rotate at the same speed and in the same direction.

Hereinafter, embodiments of the present disclosure will be described in detail with reference to the accompanying drawings.

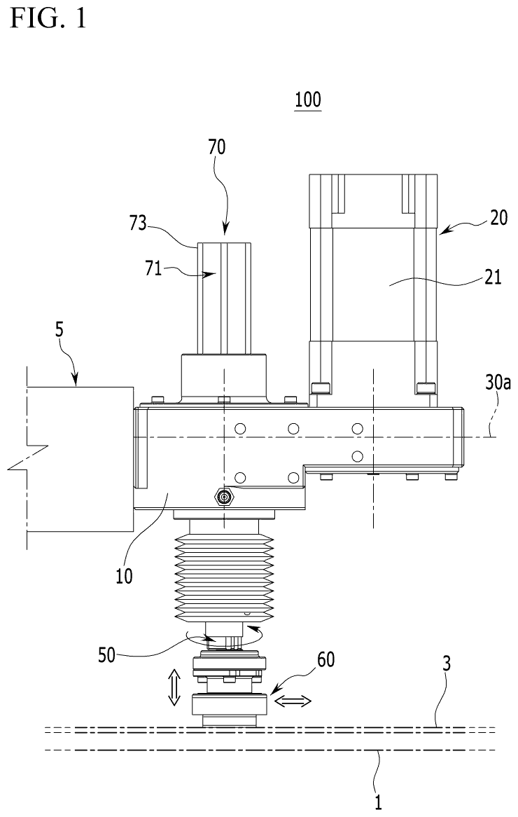

FIG. 1 is a side view illustrating a sanding device according to an embodiment of the present disclosure.

With reference to FIG. 1, a sanding device 100 according to an embodiment of the present disclosure may be applied to a coating process of coating a vehicle body 1.

The sanding device 100 according to an embodiment of the present disclosure may be applied to a coating film sanding process of removing fine foreign substances on a coating film 3 applied onto a surface of the vehicle body 1 or removing a defective portion of the coating film 3.

In this case, the sanding device 100 according to an embodiment of the present disclosure is configured to simultaneously sand the coating film 3 and regulate sanding pressure (e.g., sanding pressing force) applied to the coating film 3.

The sanding device 100 according to an embodiment of the present disclosure may be mounted on an arm of a robot 5 and moved to a preset position by a robot operation of the robot 5. The robot 5 may include an articulated robot known to those skilled in the art and configured to perform the robot operation along a preset teaching route within a working radius.

As an example, in the present specification, a reference direction for explaining the following components may be set as an upward/downward direction (e.g., a height direction) based on the drawings.

The definition of the direction is a relative meaning, and the direction may vary depending on a reference position of the sanding device 100, an operating position of the robot 5, and the like. Therefore, the reference direction is not necessarily limited to the reference direction of the present embodiment.

In addition, in the present specification, the terms ‘upper end portion,’ ‘upper portion’, ‘upper end’, or ‘upper surface’ of a component means an end portion, a portion, an end, or a surface of the component which is disposed at a relative upper side, and the terms ‘lower end portion,’ ‘lower portion’, ‘lower end’, or ‘lower surface’ of a component means an end portion, a portion, an end, or a surface of the component which is disposed at a relatively lower side.

Furthermore, in the present specification, an end (e.g., one end or the other end) of a component means an end of the component in any one direction, and an end portion (e.g., one end portion or the other end portion) of a component means a predetermined portion of the component that includes the end of the component.

The sanding device 100 according to an embodiment of the present disclosure has a structure in which a mechanism for sanding the coating film 3 and a mechanism for regulating sanding pressure are integrated into a simple configuration.

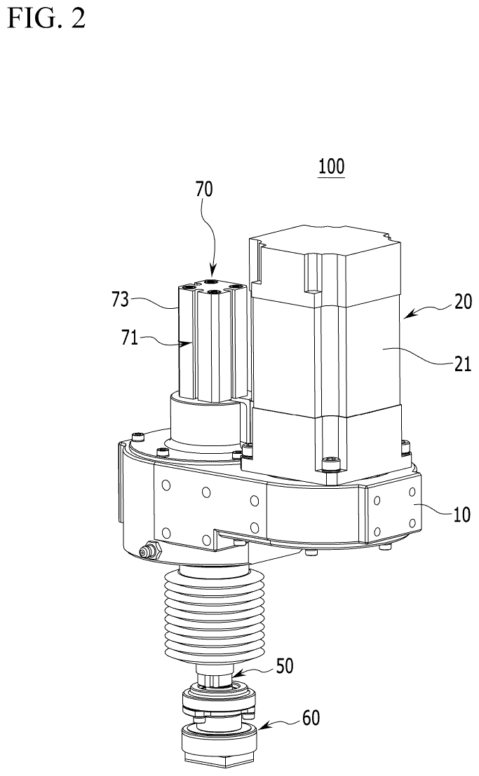

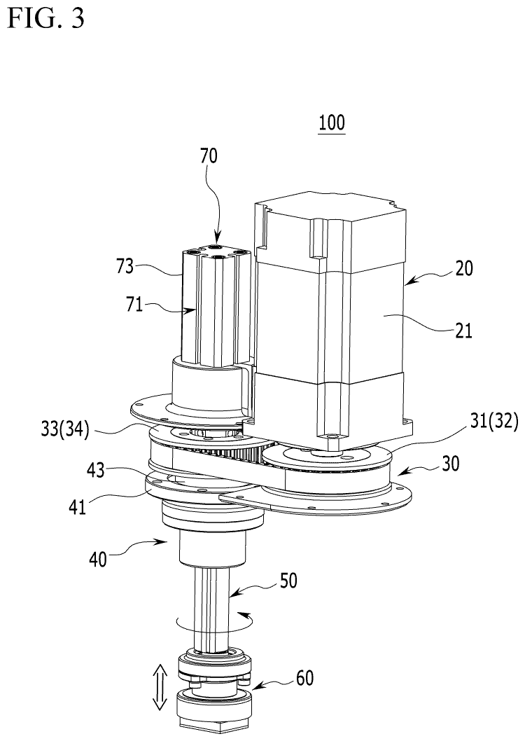

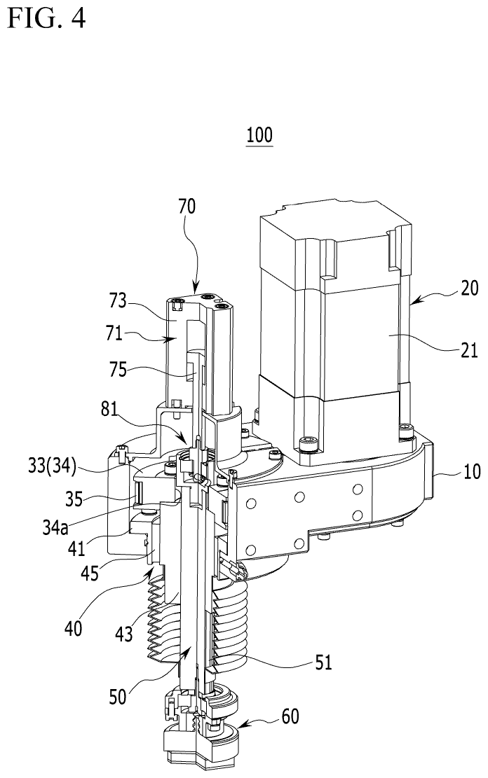

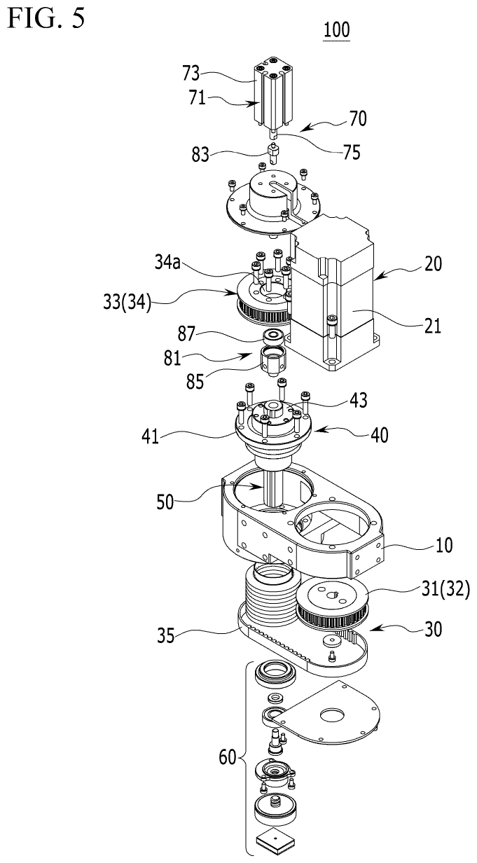

FIGS. 2 and 3 are coupled perspective views illustrating the sanding device according to an embodiment of the present disclosure, FIG. 4 is a partially cut-away perspective view illustrating the sanding device according to an embodiment of the present disclosure, and FIG. 5 is an exploded perspective view illustrating the sanding device according to an embodiment of the present disclosure.

With reference to FIGS. 1 to 5, the sanding device 100 according to an embodiment of the present disclosure includes a housing 10, a main driving source 20, a power transmission assembly 30, a shaft connecting assembly 40, a spindle shaft 50, a sanding tool assembly 60, and a sanding pressure regulating unit 70.

In an embodiment of the present disclosure, the housing 10 may be mounted on the arm of the robot 5 by a tool changer (not illustrated). The housing 10 is configured to support various types of constituent elements to be described below. The housing 10 may be configured as a single housing or two or more connected housings.

Further, the housing 10 may include various types of accessory elements such as a casing, a bracket, a block, and a plate for supporting various types of constituent elements.

However, because the various types of accessory elements serve to install various types of constituent elements in the housing 10, the accessory elements are collectively called the housing 10, except for an exceptional case, in the embodiments of the present disclosure.

In an embodiment of the present disclosure, the main driving source 20 is configured to generate rotational power. The main driving source 20 may include a motor 21 installed on the housing 10.

As an example, the motor 21 may include a servo motor capable of performing servo control on a rotational speed and a rotation direction.

In an embodiment of the present disclosure, the power transmission assembly 30 is configured to transmit rotational power of the motor 21 to a rotary component through a preset power transmission route 30a (see FIG. 1). The power transmission assembly 30 is installed in the housing 10. In this case, the power transmission route 30a may be defined as a route defined in a direction perpendicular to an axial direction of the motor 21.

The power transmission assembly 30 may include a rotational power input part 31, a rotational power output part 33, and a timing belt 35.

The rotational power input part 31 is rotatably installed in the housing 10 and operably connected to the motor 21. As an example, the rotational power input part 31 may include a driving pulley 32.

The rotational power output part 33 is operably connected to the rotational power input part 31 and rotatably installed in the housing 10. As an example, the rotational power output part 33 may include a driven pulley 34. In this case, the driven pulley 34 includes a pulley hole 34a formed at a center thereof.

Further, the timing belt 35 is configured to connect the driving pulley 32 and the driven pulley 34 in the form of an endless track.

Therefore, the driving pulley 32, the driven pulley 34, and the timing belt 35 of the power transmission assembly 30 may define the power transmission route 30a in the direction perpendicular to the axial direction of the motor 21.

In an embodiment of the present disclosure, the shaft connecting assembly 40 is configured to operably connect the driven pulley 34 of the power transmission assembly 30 and the spindle shaft 50 to be described below.

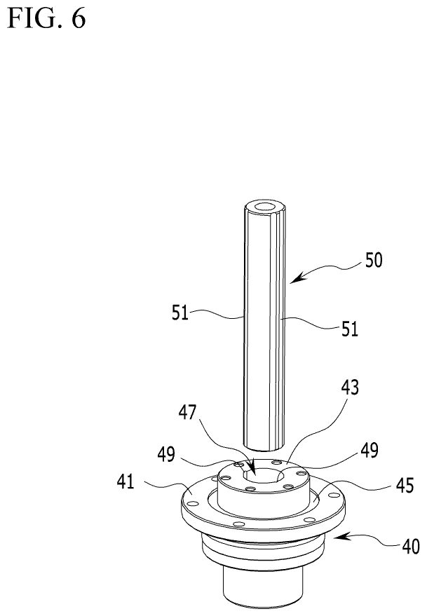

FIG. 6 is an exploded perspective view illustrating a coupling structure between the shaft connecting assembly and the spindle shaft applied to the sanding device according to an embodiment of the present disclosure.

With reference to FIGS. 3 to 6, the shaft connecting assembly 40 according to an embodiment of the present disclosure includes a spindle housing 41 and a spindle 43.

The spindle housing 41 is fixed to the housing 10 at a position corresponding to the driven pulley 34 of the power transmission assembly 30.

The spindle 43 is rotatably coupled to the spindle housing 41. The spindle 43 may be rotatably coupled to the spindle housing 41 by a spindle bearing 45. The spindle 43 is connected (e.g., coupled) to the driven pulley 34 of the power transmission assembly 30.

In this case, the spindle 43 may include a spindle hole 47 formed in a central portion in the axial direction. Furthermore, the spindle 43 includes a plurality of spline grooves 49 formed in an inner peripheral surface of the spindle hole 47 and disposed in the axial direction.

With reference to FIGS. 1 to 6, in an embodiment of the present disclosure, the spindle shaft 50 is configured to rotate together with the spindle 43 and reciprocate in the spindle 43 in the upward/downward direction based on the drawings.

The spindle shaft 50 is coupled to the spindle hole 47 of the spindle 43 so as to be movable in the axial direction (e.g., the upward/downward direction based on the drawings).

To this end, the spindle shaft 50 includes a plurality of spline protrusions 51 formed on an outer peripheral surface in the axial direction. The plurality of spline protrusions 51 may be spline-coupled to the plurality of spline grooves 49 of the spindle 43 in the axial direction.

With reference to FIGS. 1 to 5, in an embodiment of the present disclosure, the sanding tool assembly 60 is configured to sand the coating film 3 of the vehicle body 1 while being rotated by the spindle shaft 50. The sanding tool assembly 60 is installed at a lower end of the spindle shaft 50 based on the drawings.

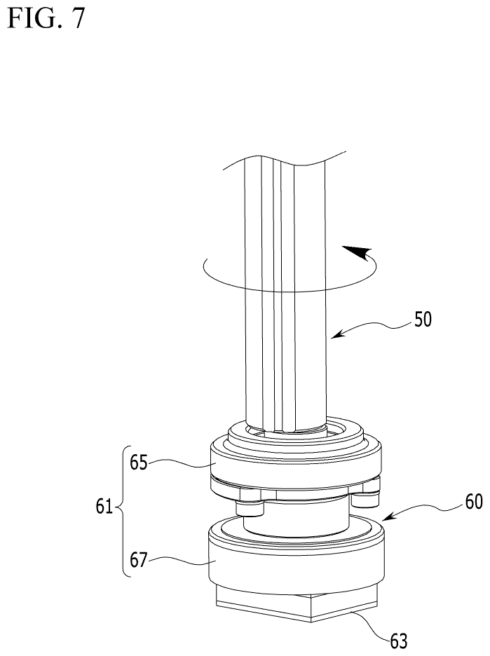

FIG. 7 is a view illustrating a part of the sanding tool assembly applied to the sanding device according to an embodiment of the present disclosure.

With reference to FIG. 7, the sanding tool assembly 60 according to an embodiment of the present disclosure includes a tool mounting part 61 coupled to the lower end of the spindle shaft 50 and a sandpaper 63 mounted on the tool mounting part 61.

As an example, the tool mounting part 61 may include a mounting plate 65 coupled to the lower end of the spindle shaft 50 and a mounting wheel 67 coupled to the mounting plate 65.

Further, the sandpaper 63 is a sanding part having preset roughness to substantially sand the coating film 3. The sandpaper 63 may be coupled to the mounting wheel 67.

In an embodiment of the present disclosure, the example is described in which the sanding part includes the sandpaper 63. However, the present disclosure is not limited thereto. The sanding part may be provided in the form of a brush capable of grinding or polishing a sanding target.

With reference to FIGS. 1 to 5, in an embodiment of the present disclosure, the sanding pressure regulating unit 70 is configured to regulate sanding pressure of the sanding tool assembly 60 applied to the coating film 3 while reciprocating (e.g., rectilinearly moving) the spindle shaft 50 in the axial direction.

That is, the sanding pressure regulating unit 70 may compensate, in real time, for a change in pressing force of the sanding tool assembly 60 caused by a movement displacement of the robot 5 during the process in which the sanding tool assembly 60 sands the coating film 3.

The sanding pressure regulating unit 70 is installed on the housing 10 and is coaxially connected to the spindle shaft 50. Furthermore, the sanding pressure regulating unit 70 may reciprocate the spindle shaft 50 in the axial direction by using preset pneumatic pressure.

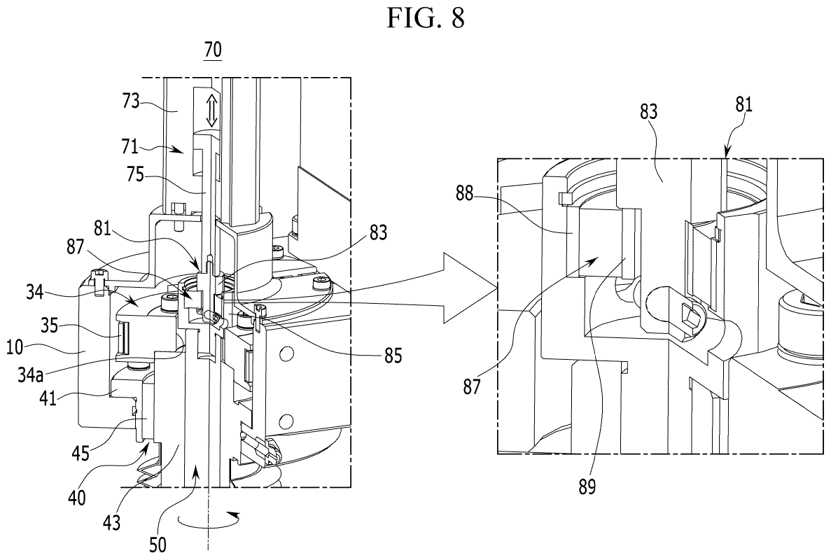

FIG. 8 is a view illustrating a part of the sanding pressure regulating unit applied to the sanding device according to an embodiment of the present disclosure.

With reference to FIG. 8, the sanding pressure regulating unit 70 according to an embodiment of the present disclosure includes a sub-driving source 71 and a shaft joint assembly 81.

The sub-driving source 71 is configured to reciprocate the spindle shaft 50 in the axial direction by the spindle 43 while applying a rectilinear movement force to the spindle shaft 50. The sub-driving source 71 may include an air cylinder 73 on the housing 10.

The air cylinder 73 may include an operating rod 75 configured to be moved forward or rearward by preset pneumatic pressure.

In this case, the preset pneumatic pressure may be defined as pressure for compensating for a change in sanding pressure of the sanding tool assembly 60 caused by a movement displacement of the robot 5 (see FIG. 1) when the sanding tool assembly 60 sands the coating film 3.

The setting of the pneumatic pressure may be implemented by a controller (not illustrated). The controller may be implemented as one or more processors configured to be operated by a preset program. In particular, the controller may be implemented as one or more processors for implementing a position recognition function known to those skilled in the art.

Further, the shaft joint assembly 81 is configured to operably connect the spindle shaft 50 and the operating rod 75 of the air cylinder 73. The shaft joint assembly 81 is installed at an upper end of the spindle shaft 50 based on the drawings and connected to the operating rod 75 of the air cylinder 73 in the axial direction of the spindle shaft 50.

In this case, the operating rod 75 and the spindle shaft 50 may be connected in the coaxial direction perpendicular to the power transmission route 30a (see FIG. 1) by the shaft joint assembly 81. Furthermore, the spindle shaft 50 may be reciprocated in the axial direction by the air cylinder 73 while being rotated by the motor 21 (see FIG. 1).

The shaft joint assembly 81 includes a push pin 83, a bearing adapter 85, and a bearing member 87.

The push pin 83 is coupled to a lower end of the operating rod 75 of the air cylinder 73. The bearing adapter 85 is coupled to the upper end of the spindle shaft 50. As an example, the bearing adapter 85 may be provided in the form of a bushing.

In this case, the bearing adapter 85 is disposed in the above-mentioned pulley hole 34a of the driven pulley 34 of the power transmission assembly 30. The bearing adapter 85 may be coupled to the upper end of the spindle shaft 50 through the pulley hole 34a.

Further, the bearing member 87 is fixed to the bearing adapter 85 and connected to the push pin 83. As an example, the bearing member 87 may be provided as a ball bearing having an outer race 88 and an inner race 89.

The bearing member 87 may be coupled to the bearing adapter 85 by the outer race 88 and coupled to the push pin 83 by the inner race 89.

Hereinafter, an operation of the sanding device 100 according to an embodiment of the present disclosure described above will be described in detail with reference to FIGS. 1 to 8.

First, the sanding device 100 according to an embodiment of the present disclosure is mounted on the arm of the robot 5.

In the sanding device 100 according to an embodiment of the present disclosure, the spindle shaft 50 is spline-coupled to the spindle 43 so as to reciprocate in the axial direction.

Further, the spindle shaft 50 is coaxially connected to the operating rod 75 of the air cylinder 73 by the shaft joint assembly 81 including the push pin 83, the bearing adapter 85, and the bearing member 87.

In addition, the sanding tool assembly 60 including the sandpaper 63 is mounted on the spindle shaft 50.

In this state, the sanding device 100 according to an embodiment of the present disclosure is moved by the robot 5 toward the coating film 3 applied onto the vehicle body 1.

When the motor 21 operates during this process, rotational power of the motor 21 is inputted to the driving pulley 32 of the power transmission assembly 30 and transmitted to the driven pulley 34 through the timing belt 35. In this case, the driving pulley 32 is rotated by the operation of the motor 21, and the driven pulley 34 is rotated together with the driving pulley 32 by the timing belt 35.

As the driven pulley 34 rotates as described above, the spindle 43 of the shaft connecting assembly 40 rotates, the spindle shaft 50 is rotated by the spindle 43, and the sanding tool assembly 60 is rotated by the spindle shaft 50.

In this case, because the spindle shaft 50 is connected to the operating rod 75 of the air cylinder 73 by the shaft joint assembly 81, the spindle shaft 50 may rotate without interfering with the operating rod 75.

In this case, the sanding tool assembly 60, which is rotated by the spindle shaft 50, sands the coating film 3 by means of the sandpaper 63 while pressing the coating film 3 of the vehicle body 1 with a preset pressing force by the robot 5.

Therefore, the sanding tool assembly 60 may remove fine foreign substances on the coating film 3 or a defective portion of the coating film 3 using the sandpaper 63 while being moved by the robot operation of the robot 5.

For example, the sanding pressure applied to the coating film 3 may be changed by the movement displacement of the robot 5 on a curved portion of the vehicle body 1 during the process in which the sanding tool assembly 60 sands the coating film 3 of the vehicle body 1, as described above.

In this case, in an embodiment of the present disclosure, the controller applies preset pneumatic pressure to the air cylinder 73. Then, the operating rod 75 of the air cylinder 73 is moved forward and rearward by the pneumatic pressure.

Therefore, the spindle shaft 50 is reciprocated in the axial direction using the spindle 43 by the forward and rearward operations of the operating rod 75 in the state in which the spindle shaft 50 rotates.

In this case, the push pin 83 is coupled to the lower end of the operating rod 75, and the bearing adapter 85 is coupled to the upper end of the spindle shaft 50. Further, the bearing member 87 is coupled to the bearing adapter 85 by the outer race 88 and coupled to the push pin 83 by the inner race 89.

Therefore, as the forward and rearward operating forces of the operating rod 75 are applied to the inner race 89 of the bearing member 87 through the push pin 83, the operating rod 75 may reciprocate the spindle shaft 50 together with the bearing adapter 85 in the axial direction without hindering the rotation of the spindle shaft 50.

Therefore, as the spindle shaft 50 reciprocates in the axial direction as described above, the sanding pressure of the sanding tool assembly 60, which is applied to the coating film 3, may be regulated (e.g., changed) by the movement displacement of the robot 5.

Therefore, the sanding device 100 according to an embodiment of the present disclosure may sand the coating film 3 of the vehicle body 1 with a uniform thickness while regulating (or compensating for) the sanding pressure of the sanding tool assembly 60 in accordance with the movement displacement of the robot 5.

According to the sanding device 100 according to an embodiment of the present disclosure described above, the spindle shaft 50, which is configured to rotate the sanding tool assembly 60, and the sanding pressure regulating unit 70, which regulates the sanding pressure of the sanding tool assembly 60, may be coaxially connected and integrally mounted in the single housing 10.

Therefore, according to the sanding device 100 according to an embodiment of the present disclosure, an overall weight and manufacturing costs may be reduced, and facility investment costs may be reduced because the sanding device 100 may be applied to the small-scale robot.

Furthermore, the sanding device 100 according to an embodiment of the present disclosure decreases in weight, which is advantageous in precisely controlling the operating position of the robot, and the sanding pressure regulating unit 70 may regulate and maintain fine pressure of the sanding tool assembly 60.

While embodiments of the invention have been described in connection with what is presently considered to be practical example embodiments, it is to be understood that the embodiments of the invention are not limited to the disclosed embodiments, but, on the contrary, are intended to cover various modifications and equivalent arrangements included within the spirit and scope of the appended claims.

The following reference identifiers may be used in connection with the drawings to describe various features of embodiments of the present disclosure.

| | |
|---|---|
| 1: Vehicle body | 3: Coating film |
| 5: Robot | 10: Housing |
| 20: Main driving source | 21: Motor |
| 30: Power transmission assembly | 30a: Power transmission route |
| 31: Rotational power input part | 32: Driving pulley |
| 33: Rotational power output part | 34: Driven pulley |
| 34a: Pulley hole | 35: Timing belt |
| 40: Shaft connecting assembly | 41: Spindle housing |
| 43: Spindle | 45: Spindle bearing |
| 47: Spindle hole | 49: Spline groove |
| 50: Spindle shaft | 51: Spline protrusion |
| 60: Sanding tool assembly | 61: Tool mounting part |
| 63: Sandpaper | 65: Mounting plate |
| 67: Mounting wheel | 70: Sanding pressure regulating unit |
| 71: Sub-driving source | 73: Air cylinder |
| 75: Operating rod | 81: Shaft joint assembly |
| 83: Push pin | 85: Bearing adapter |
| 87: Bearing member | 88: Outer race |
| 89: Inner race | 100: Sanding device |

What is claimed is:

1. A sanding device comprising:
a housing mountable on an arm of a robot;
a sanding tool assembly rotatably installed on the housing by a spindle shaft; and
a sanding pressure regulating unit coaxially connected to the spindle shaft and configured to regulate sanding pressure of the sanding tool assembly applied to a coating film while reciprocating the spindle shaft in an axial direction.

2. The sanding device of claim 1, further comprising:
a main driving source comprising a motor disposed on the housing;
a power transmission assembly disposed in the housing and configured to transmit rotational power of the motor to the spindle shaft along a preset power transmission route; and
a shaft connecting assembly connected to a rotational power output part of the power transmission assembly and configured such that the spindle shaft is coupled to the shaft connecting assembly so as to be movable in the axial direction.

3. The sanding device of claim 2, wherein the sanding pressure regulating unit comprises:
a sub-driving source comprising an air cylinder disposed on the housing; and
a shaft joint assembly disposed on the spindle shaft and connected to the air cylinder in the axial direction of the spindle shaft.

4. The sanding device of claim 3, wherein the spindle shaft and the air cylinder are connected by the shaft joint assembly in a coaxial direction perpendicular to the power transmission route.

5. The sanding device of claim 3, wherein the spindle shaft is configured to be reciprocated in the axial direction by the air cylinder while being rotated by an operation of the motor.

6. A sanding device comprising:
a housing mountable on an arm of a robot;
a main driving source comprising a motor disposed on the housing;
a power transmission assembly comprising a rotational power input part connected to the motor and a rotational power output part connected to the rotational power input part;
a spindle rotatably coupled to a spindle housing fixed to the housing, the spindle being connected to the rotational power output part;
a spindle shaft coupled to the spindle so as to be movable in an axial direction;
a sanding tool assembly disposed on the spindle shaft; and
a sanding pressure regulating unit coaxially connected to the spindle shaft and configured to regulate sanding pressure of the sanding tool assembly applied to a coating film while reciprocating the spindle shaft in the axial direction by an operation of a sub-driving source.

7. The sanding device of claim 6, wherein the sanding pressure regulating unit comprises a shaft joint assembly disposed on the spindle shaft and connected to the sub-driving source.

8. The sanding device of claim 6, wherein:
the rotational power input part comprises a driving pulley, the driving pulley being rotatably disposed in the housing;
the rotational power output part comprises a driven pulley, the driven pulley being connected to the spindle.

9. The sanding device of claim 8, wherein the power transmission assembly further comprises a timing belt configured to connect the driving pulley and the driven pulley in a form of an endless track.

10. The sanding device of claim 6, wherein the spindle comprises:
a spindle hole disposed in the axial direction; and
a plurality of spline grooves disposed in an inner peripheral surface of the spindle hole in the axial direction.

11. The sanding device of claim 10, wherein the spindle shaft comprises a plurality of spline protrusions disposed on an outer peripheral surface thereof in the axial direction and coupled to the plurality of spline grooves.

12. The sanding device of claim 6, wherein the sanding tool assembly comprises:
a tool mounting part coupled to the spindle shaft; and
a sandpaper mounted on the tool mounting part.

13. A sanding device comprising:
a housing mountable on an arm of a robot;
a main driving source comprising a motor disposed on the housing;
a power transmission assembly comprising a rotational power input part connected to the motor and a rotational power output part connected to the rotational power input part;
a spindle rotatably coupled to a spindle housing fixed to the housing, the spindle being connected to the rotational power output part;
a spindle shaft coupled to the spindle so as to be movable in an axial direction;
a sanding tool assembly disposed on the spindle shaft; and
a sanding pressure regulating unit coaxially connected to the spindle shaft and configured to regulate sanding pressure of the sanding tool assembly applied to a coating film while reciprocating the spindle shaft in the axial direction by an operation of a sub-driving source, the sanding pressure regulating unit comprising a shaft joint assembly disposed on the spindle shaft and connected to the sub-driving source, the sub-driving source comprising an air cylinder disposed on the housing and coaxially connected to the shaft joint assembly by an operating rod.

14. The sanding device of claim 13, wherein the shaft joint assembly comprises:
a push pin coupled to the operating rod of the air cylinder;
a bearing adapter coupled to the spindle shaft; and
a bearing member fixed to the bearing adapter and connected to the push pin.

15. The sanding device of claim 14, wherein the bearing member is coupled to the bearing adapter by an outer race and coupled to the push pin by an inner race.

16. The sanding device of claim 14, wherein:
the rotational power output part comprises a driven pulley; and
the bearing adapter comprises a bushing and is coupled to the spindle shaft through a pulley hole disposed in the driven pulley.

17. The sanding device of claim 13, wherein the spindle comprises:
a spindle hole disposed in the axial direction; and
a plurality of spline grooves disposed in an inner peripheral surface of the spindle hole in the axial direction.

18. The sanding device of claim 17, wherein the spindle shaft comprises a plurality of spline protrusions disposed on an outer peripheral surface thereof in the axial direction and coupled to the plurality of spline grooves.

19. The sanding device of claim 18, wherein the sanding tool assembly comprises:
a tool mounting part coupled to the spindle shaft; and
a sandpaper mounted on the tool mounting part.

20. The sanding device of claim 13, wherein the sanding tool assembly comprises:
a tool mounting part coupled to the spindle shaft; and
a sandpaper mounted on the tool mounting part.
